(19) United States
(12) Patent Application Publication
(10) Pub. No.: US 2004/0074825 A1
(43) Pub. Date: Apr. 22, 2004

(54) Centrifuge configuration recall and retrieval system and method

(76) Inventors: Harvey Schneider, Southbury, CT (US); Karl Kregling, Seymour, CT (US)

Correspondence Address: BAKER & HOSTETLER LLP, Washington Square, Suite 1100, 1050 Connecticut Avenue, N.W., Washington, DC, 20036, US

(21) Appl. No.: 10/441,283

(22) Filed: May 20, 2003

Related U.S. Application Data
(60) Provisional application No. 60/381,791, filed on May 21, 2002.

(51) Int. Cl. B01D 21/30

(52) U.S. Cl. 210/85; 210/143; 494/10

(57) ABSTRACT

Methods and apparatus for a centrifuge control system, which are particularly suited for recalling and retrieving centrifuge protocols and set-up parameters.

### PRIORITY

This application claims priority to the provisional U.S. patent application entitled CENTRIFUGE CONFIGURATION RECALL AND RETRIEVAL SYSTEM, filed May 21, 2002, having a serial No. 60/381,791, the disclosure of which is hereby incorporated by reference.

### FIELD OF THE INVENTION

The present invention relates generally to centrifuge controls. More particularly, the present invention relates to a control system for recalling and retrieving the protocols and parameters of a centrifuge.

### BACKGROUND OF THE INVENTION

A centrifuge instrument is a device by which liquid samples may be subjected to centrifugal forces in order to separate colloidal particles suspended in a liquid or solution. The sample is carried within a member known as a centrifuge rotor. The rotor is mounted to a rotatable drive shaft that is connected to a source of motive energy.

A typical centrifuge set-up may include a centrifuge tube which holds a sample for separation. A plurality of centrifuge tubes may be located and retained on a rotor of the centrifuge. The rotor of the centrifuge is commonly configured to be contained in a compartment and spun about a central axis in order to achieve separation of the sample. A rotatable drive shaft may be connected to the centrifuge rotor in order to facilitate spinning of the rotor assembly. The rotatable drive shaft may be further connected to a source of motive energy in order to receive power.

Centrifuges are currently employed in many industrial and research situations, such as, for example, laboratories. Laboratory centrifuges are generally operated by manual controls using various settings and procedures. The calibration of the centrifuge is important in order to achieve proper separation of particles within test samples during testing under controlled operating conditions. An operator may want to set various aspects of the testing condition or indicated specific components coupled to the system of the centrifuge. This information could be further conveyed to a processor located within the centrifuge and be utilized for preparing the centrifuge to operate under a prescribed testing condition.

An example of relayed information that can set up a condition of the centrifuge may include a rotor control used to set the specific size or type of rotor used within the centrifuge. This would allow the centrifuge to operate a given rotor assembly at preferred power levels. Different rotors are capable of operating at different speeds and are further capable of generating different centripetal forces. Such control would be preferable in order to operate a given rotor at a peak efficiency and prescribed rotational forces and/or speeds.

Additionally, a temperature control and a timer control may also be set in accordance with a type of sample being tested. It may be important to maintain a certain operating temperature for the test sample over a given period of time. This may also include requirements for a sample to sit at an operation temperature for a prescribed time before and/or after testing within the centrifuge. This temperature would be regulated by the temperature control of the centrifuge. The length of time that the sample would be subjected to specific temporal conditions would be regulated by the time control.

An operator may also want to apply the centrifugal force generated by the rotor over a regulated time period. This, of course, would depend on the goals for testing a product and the test sample itself. Additional controls may also include conventional power switches provided on the centrifuge device to manually turn the unit on or off as needed.

Thus, it is clear that the ability to control functions of the centrifuge can be advantageous to a user and the samples being tested. Having a greater flexibility to control the testing environment would yield a greater variety of functions in the testing capabilities provided by the centrifuge. While technological advances have made it easier to calibrate and control operations of the centrifuge, there remain some functions which still require extensive set-up or waste resources during “down-times.” For example, if a user desired to have a centrifuge readily available with the most recent run protocols easily accessible for future use, the user would have to re-apply similar or the same run protocols each and every time a particular centrifuge run was desired. This method of operating the centrifuge can cause undesirable set-up delays and even possible input errors by the user of the established protocols for a particular centrifuge run.

If a user desires to have a centrifuge readily available for samples, the user must input the proper protocols and set-up parameters in order to have a successful centrifuge run. Parameters are the individual characteristics of a centrifuge run such as time of run, speed of rotor, and temperature of run. A protocol is a set of parameters that, together, comprise all of the individual settings for a particular centrifuge run.

If the protocols and/or set-up parameters are entered in error, the samples and time may be lost or wasted. A user may choose to save a protocol, but the user will have to perform an affirmative action to store the protocol in memory.

The present invention overcomes the prior art problems by utilizing a centrifuge protocol and parameter recall and retrieval control system and method that automatically stores parameters and protocols in memory.

### SUMMARY OF THE INVENTION

It is therefore a feature of the present invention to provide a control system for recall and retrieval of protocols and parameters of a centrifuge. The control system, comprises a centrifuge and a controller with electronic memory storage capabilities, such as random-access memory (RAM), wherein the controller saves to memory the centrifuge protocols of multiple centrifuge runs, the protocols comprising parameters of a centrifuge run.

The above and other features are achieved through the use of a novel centrifuge protocol and parameter recall and retrieval control system as herein disclosed. In accordance with one embodiment of the present invention, a control system is provided for recalling the most recently used protocols and parameters. The system comprises a centrifuge and a controller for use with a centrifuge. The system automatically saves the parameters and protocol of a centrifuge run. And, the system permits the user to recall and retrieve one of the last of several sets of protocols and parameters used. The retrieved parameters may be modified by the user as well.

In accordance with another embodiment of the present invention, a method is provided for recalling and retrieving recently used centrifuge protocols and parameters. The method for saving, recalling, and retrieving protocols of a centrifuge run, comprises the steps of selecting parameters for a centrifuge run; retrieving a protocol saved by a controller; running the protocol; and saving the protocol in a memory of the controller, the protocols comprising parameters of a centrifuge run.

The method may also comprise the step of recalling the most recently run protocols and parameters, retrieving a particular protocol, and running that protocol. The method may further comprise modifying the parameters of a protocol after it has been recalled and retrieved. The method also contemplates saving the protocol and its parameters to memory automatically.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a centrifuge of one preferred embodiment of the present invention showing the centrifuge controller.

FIG. 2 shows a flow chart illustrating the method steps of a preferred embodiment of the present invention.

FIG. 3 shows a control panel from the centrifuge controller of one preferred embodiment of the present invention.

### DESCRIPTION OF THE INVENTION

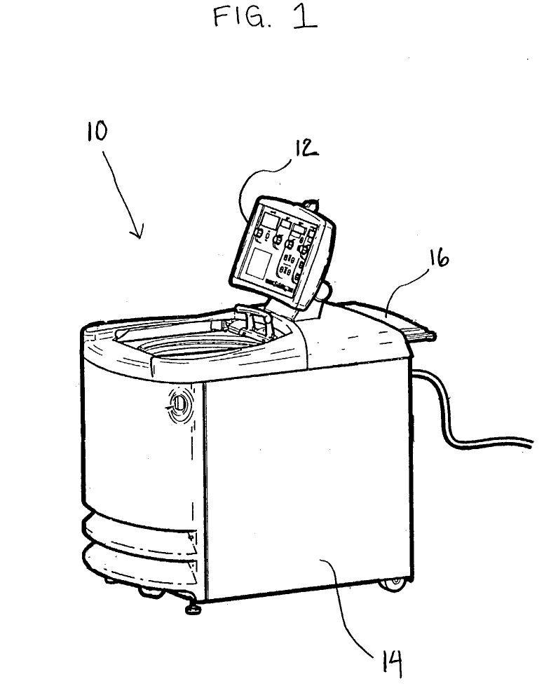

Referring to FIG. 1, a preferred embodiment of the invention provides a centrifuge 10 including a centrifuge controller 12, a housing 14, and a centrifuge access door 16. The centrifuge controller 12 may receive or accept parameter inputs as well as display set protocols or parameter information.

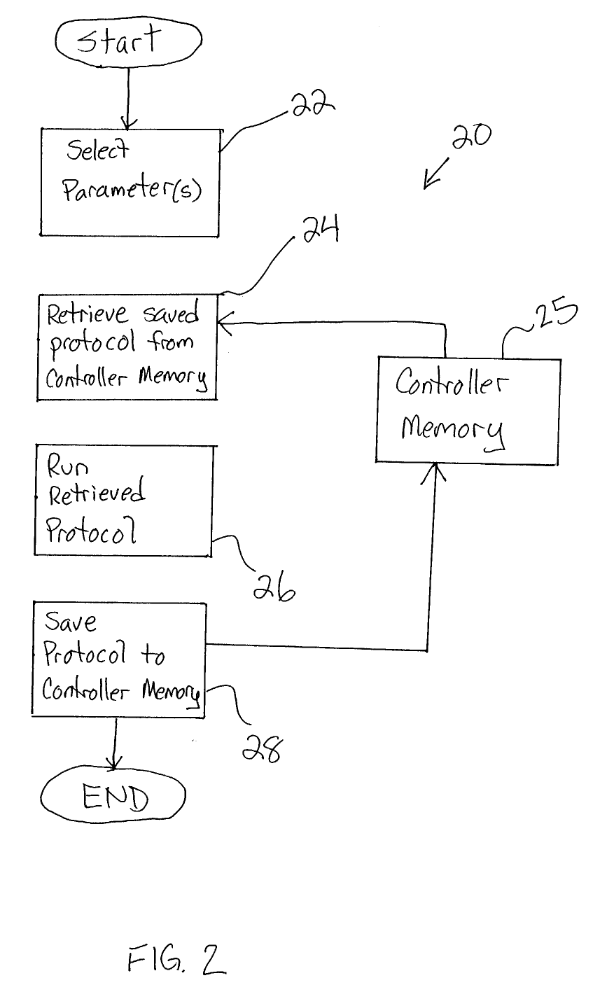

Referring to FIG. 2, a preferred method of the invention would include a protocol recall 20 that would require the selection of parameters 22 and the retrieval of saved/stored protocols 24 from a controller memory 25. Once these steps have occurred, the retrieved protocol(s) are run 26 via the controller 12 and saved 28 into the controller memory 25 for subsequent use and retrieval when needed.

The preferred method may store parameter or protocol information and allows this information to be readily retrieved by the centrifuge controller 12 resulting in saving the user the extra steps of setting up the protocol initially or repeatedly. The method also acts as a reminder to the user of what are the current protocol settings and reduces the opportunity and frequency of errors. The recall feature of the present invention may further display a number of the most recent centrifuge runs and all of the associated set parameters.

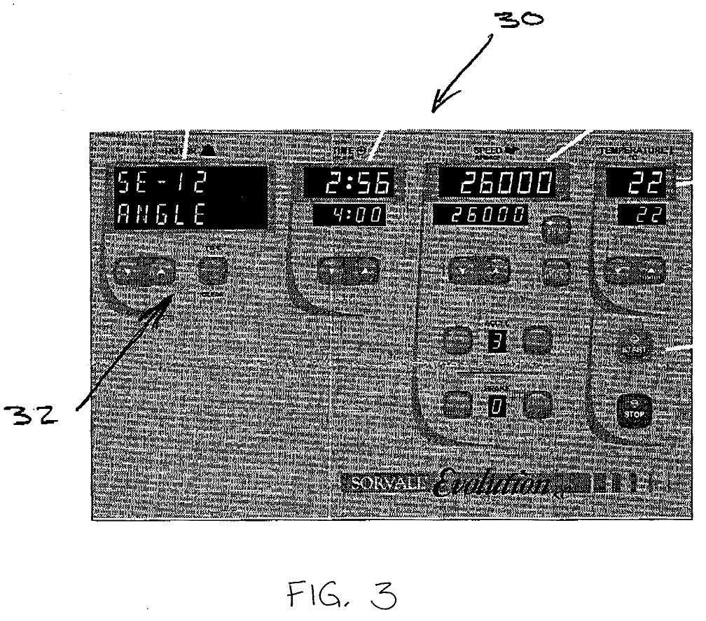

Referring to FIG. 3, several parameters can be selected by a user before operating a centrifuge 10. These parameters comprise the protocol for that run of the centrifuge 10. Parameters to be chosen may include the choice of rotor to be used, the time length of the run, the speed of the rotor (measured in revolutions per minute or by the force applied to the samples), and the temperature inside the centrifuge 10. A user may also choose the acceleration and braking rates of the centrifuge 10.

The present invention may comprise software that automatically stores the parameters chosen by the user. For example, the invention may store the last five (5) sets of unique protocols for easy recall and retrieval. The control panel 30 of the present invention may be analog or digital. The control panel 30 may have push buttons 32 and scrolling options to choose parameters, or the control panel 30 may have a touch screen interface.

A user may choose the presented protocol or scroll to the second most recent protocol, third most recent, and so forth. After choosing a protocol, the user may choose to run the selected protocol or modify protocol settings.

In the preferred embodiment, if a user chooses a protocol that is already stored in memory, that protocol becomes the most recent protocol in the list, and it is removed from its previous place in the list. No protocol will be repeated in the list of most recent protocols. Thus, the user will be presented with a list of unique protocols to select from.

If the user chooses a protocol and then modifies it, the modified protocol will be saved as the most recent protocol used. If the unmodified protocol that was originally chosen is still one of the most recent protocols, including the modified protocol, then both will be saved in the list of protocols available for choice by the user on the next run.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A control system, comprising:
a centrifuge; and
a controller,
wherein said controller saves centrifuge protocols of multiple centrifuge runs, said protocols comprising parameters of a centrifuge run.

2. The control system of claim 1, wherein said controller has electronic memory.

3. The control system of claim 2, wherein the protocols saved by the controller are each unique.

4. The control system of claim 2, wherein the controller further recalls the protocols.

5. The control system of claim 4, wherein the controller further retrieves the protocols.

6. The control system of claim 1, wherein the protocols include rotor type, run time length, rotor speed and internal temperature.

7. An apparatus for saving, recalling, and retrieving protocols of a centrifuge run, comprising:
a controller, wherein said controller saves centrifuge protocols of multiple centrifuge runs, said protocols comprising parameters of a centrifuge run.

8. The apparatus of claim 7, wherein said controller has electronic memory.

9. The apparatus of claim 8, wherein the protocols saved by the controller are each unique.

10. The apparatus of claim 8, wherein the controller further recalls the protocols.

11. The apparatus of claim 10, wherein the controller further retrieves the protocols.

12. The apparatus of claim 7, wherein the protocols include rotor type, run time length, rotor speed and internal temperature.

13. A method for saving, recalling, and retrieving protocols of a centrifuge run, said method comprising the steps of:
selecting a parameter for a centrifuge run;
retrieving saved protocols from a controller memory;
running said protocol; and
saving said protocol to said controller memory,
wherein said protocol comprises parameters of a centrifuge run.

14. The method of claim 13, further comprising the step of modifying at least one of said parameters of the protocol after the retrieving step.

15. The method of claim 13, further comprising the step of recalling the most recent centrifuge run.

16. An apparatus for saving, recalling, and retrieving protocols of a centrifuge run, comprising:
means for saving centrifuge protocols of multiple centrifuge runs, said protocols comprising parameters of a centrifuge run.

17. The apparatus of claim 16, wherein the protocols saved are each unique.

18. The apparatus of claim 16, further comprising means for recalling the protocols.

19. The apparatus of claim 17, further comprising means for retrieving the protocols.

20. The apparatus of claim 16, wherein said means for saving is an electronic memory.
